(19) United States
(12) Patent Application Publication
(10) Pub. No.: US 2024/0377017 A1
(43) Pub. Date: Nov. 14, 2024

(54) LOCKING MOUNTING STRUCTURE AND PHOTOGRAPHIC DEVICE USING THE SAME

(71) Applicant: TILTA INC., Burbank, CA (US)

(72) Inventors: Shengzhao Liu, Shenzhen (CN); Wenping Zeng, Shenzhen (CN); Kefeng Zhou, Shenzhen (CN)

(21) Appl. No.: 18/208,437

(22) Filed: Jun. 12, 2023

(30) Foreign Application Priority Data
May 12, 2023 (CN) 2023211526744

(51) Int. Cl. F16M 11/04; G03B 17/56

(52) U.S. Cl. CPC F16M 11/041; G03B 17/561

(57) ABSTRACT

Aspects of the present disclosure provide a locking mounting structure and a device using the locking mounting structure. The locking mounting structure includes a mounting body, wherein the mounting body is provided with a clamping piece and a locking toggle. The clamping piece is fixedly arranged on the mounting body, the locking toggle is movably arranged on the mounting body, a clamping space for mounting an external structure is provided between the locking toggle and the clamping piece, the locking toggle is further provided with a clamping part, and the locking toggle moves on the mounting body to control the clamping part to cooperate with the clamping piece to clamp the external structure, or to control the clamping part to move to loosen the external structure.

### CROSS-REFERENCE TO RELATED APPLICATIONS

The present Application for Patent claims priority to and the benefit of pending Chinese Utility Model Application No. 2023211526744, filed May 12, 2023, and hereby expressly incorporated by reference herein as if fully set forth below in its entirety and for all applicable purposes.

### TECHNICAL FIELD

The present disclosure relates to the technical field of photographic equipment, in particular to a locking mounting structure and a photographic device using the locking mounting structure.

### INTRODUCTION

At present, in the field of photographic equipment, workers or users usually need to mount various accessories, such as follow-focus equipment. The common mounting structure or mechanism includes a clamping piece with two clamping arms arranged on an accessory, and then a locking screw passes through one of the clamping arms of the clamping piece. By turning the locking screw, the two clamping arms of the clamping piece are clamped or tightened, so that the accessory is locked on the photographic device. However, when mounting an accessory, this method requires the clamping piece to slide into the photographic device in the horizontal direction, which limits the action of accessory mounting and thus affects the mounting efficiency.

### BRIEF SUMMARY

The following presents a summary of one or more implementations in order to provide a basic understanding of such implementations. This summary is not an extensive overview of all contemplated implementations and is intended to neither identify key or critical elements of all implementations nor delineate the scope of any or all implementations. Its sole purpose is to present some concepts of one or more implementations in a form as a prelude to the more detailed description that is presented later.

Aspects of the present disclosure provide a locking mounting structure and a device using the locking mounting structure. The locking mounting structure includes a mounting body, wherein the mounting body is provided with a clamping piece and a locking toggle. The clamping piece is fixedly arranged on the mounting body. The locking toggle is movably arranged on the mounting body. A clamping space for mounting an external structure is provided between the locking toggle and the clamping piece. The locking toggle is further provided with a clamping part, and the locking toggle moves on the mounting body to control the clamping part to cooperate with the clamping piece to clamp or secure the external structure, or to control the clamping part to move to loosen or release the external structure. In some aspects, the external structure may be mounted on the structure along a vertical or horizontal direction. The mounting methods are more diverse, and the mounting positions can be more quickly aligned for mounting, thus optimizing the mounting operation.

In some aspects, the present disclosure provides a locking mounting structure and a photographic device using the locking mounting structure, which is convenient to quickly lock/unlock and mount/unmount an external structure, and can effectively improve the mounting efficiency.

In some aspects, a locking mounting structure includes a mounting body, wherein the mounting body is provided with a clamping piece and a locking toggle, the clamping piece is fixedly arranged on the mounting body, the locking toggle is movably arranged on the mounting body, a clamping space for mounting an external structure is provided between the locking toggle and the clamping piece, the locking toggle is further provided with a clamping part, and the locking toggle moves on the mounting body to control the clamping part to cooperate with the clamping piece to clamp the external structure, or to control the clamping part to move to loosen the external structure.

In the locking mounting structure, when mounting the external structure, the external structure can be directly mounted into the clamping space, and the clamping part is controlled to cooperate with the clamping piece to clamp the external structure through the movable locking toggle, so as to realize the mounting and locking process of the external structure. Compared with the slide-in mounting structure, the external structure may be mounted on the structure along a vertical or horizontal direction, the mounting methods are more diverse, and the mounting positions can be more quickly aligned for mounting, thus optimizing the mounting operation.

Further, the locking mounting structure further includes a positioning piece, the positioning piece is arranged on the mounting body, and the locking toggle is rotatably sleeved on the positioning piece. The locking toggle moves around the positioning piece to control the clamping part to cooperate with the clamping piece to clamp the external structure, or to control the clamping part to move to loosen the external structure.

Further, a lateral surface of the clamping part is cambered, and the locking toggle is arranged to be rotatable in an eccentric circle around the positioning piece, so that the locking toggle can rotate in an eccentric circle around the positioning piece. The lateral surface of the clamping part is cambered, which can avoid scratching the external structure mounted in the clamping space. The locking toggle rotates in an eccentric circle around the positioning piece to control the clamping part to move into or out of the clamping space, so as to realize clamping or loosening the external structure.

Further, a wrench for controlling the movement of the locking toggle is provided at one end of the locking toggle, and the clamping part is located at a side of the other end of the locking toggle.

Further, one side of the clamping part facing the mounting body is provided with a first inclined plane, and the clamping piece is provided with a second inclined plane corresponding to the first inclined plane. With the arrangement of the first inclined plane and the second inclined plane, the clamping part can cooperate with the clamping piece to clamp the external structure more stably.

Further, the mounting body is provided with a limiting protrusion corresponding to the locking toggle for limiting a rotation angle of the locking toggle, and the locking toggle is provided with a limiting groove corresponding to the limiting protrusion. The cooperation between the limiting groove and the limiting protrusion can enhance the limiting effect.

Further, the mounting body is provided with a contact probe in the clamping space for electrical connection. Due to the arrangement of the contact probe, the locking mounting structure cannot only lock the external structure, but also be electrically connected with the external structure.

Further, the mounting body is provided with a safety pin in the clamping space for extending into the external structure. After the external structure is mounted in the clamping space, the safety pin extends into the corresponding slot of the external structure, thus providing the functions of limiting and preventing falling off.

Further, the mounting body is provided with a safety pin groove in the clamping space, the safety pin is movably arranged in the safety pin groove, and a spring is further arranged between the safety pin and the safety pin groove.

A photographic device includes the locking mounting structure described above, wherein the locking mounting structure is mounted on the photographic device through the mounting body or the clamping space. In the photographic device, the external structure may be mounted on the photographic device, and the mounting body is mounted with accessories of the photographic device; or the mounting body may be mounted on the photographic device, and the accessories of the photographic device are mounted with an external structure, so that it is faster and more convenient to mount accessories on the photographic device.

The present disclosure has the advantages: in the locking mounting structure, when mounting the external structure, the external structure can be directly mounted into the clamping space, and the clamping part is controlled to cooperate with the clamping piece to clamp the external structure through the movable locking toggle, so as to realize the mounting and locking process of the external structure. Compared with the slide-in mounting structure, the external structure may be mounted on the structure along a vertical or horizontal direction, the mounting methods are more diverse, and the mounting positions can be more quickly aligned for mounting, thus optimizing the mounting operation.

### BRIEF DESCRIPTION OF THE DRAWINGS

FIG. 1 is a schematic diagram of a locking mounting structure from a first perspective according to some aspects of the present disclosure.

FIG. 2 is a schematic diagram of the locking mounting structure from a second perspective according to some aspects of the present disclosure.

FIG. 3 is an exploded view of the locking mounting structure of FIGS. 1 and 2 of the present disclosure.

FIG. 4 is a conceptual diagram of a photographic device with the locking mounting structure according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, these concepts may be practiced without these specific details. In some instances, well-known structures and components are shown in block diagram form in order to avoid obscuring such concepts.

In order to make the object, technical schemes, and advantages of the present disclosure clearer, the present disclosure will be further described in detail with reference to the accompanying drawings and embodiments. It should be understood that the specific embodiments described here are intended for illustrating the present disclosure, but not for limiting the present disclosure.

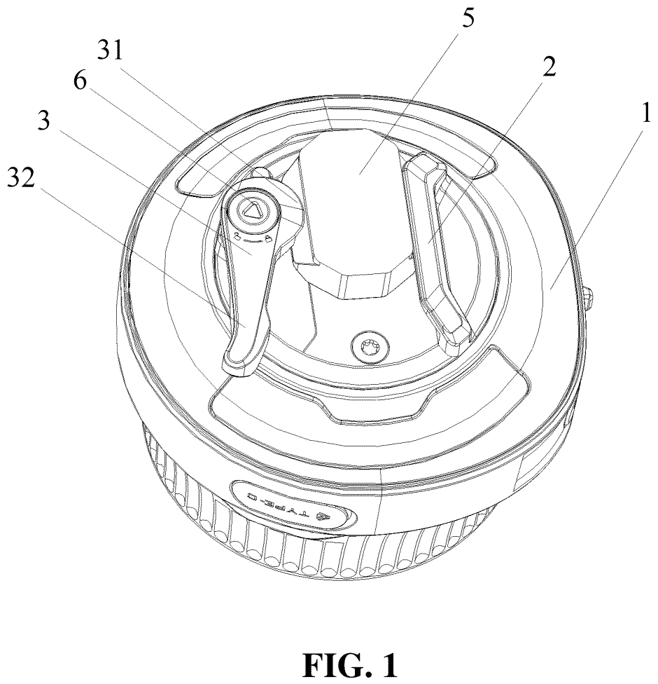

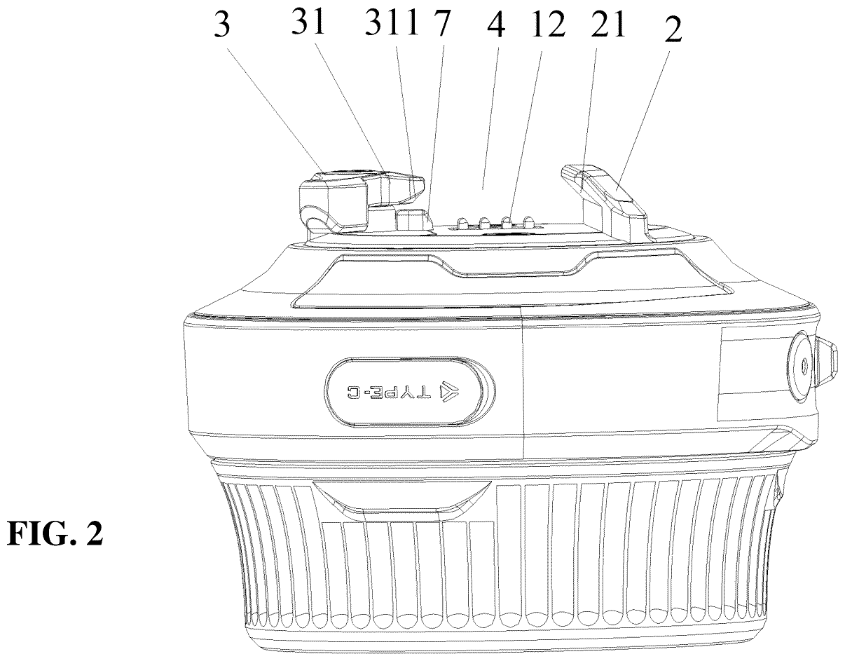

Referring to FIGS. 1 to 3, some aspects of the disclosure provide a locking mounting structure (e.g., locking mounting mechanism). The locking mounting structure includes a mounting body 1, a clamping piece 2, and a locking toggle 3 arranged on the mounting body 1. The clamping piece 2 is fixedly arranged on the mounting body 1, and the locking toggle 3 is movably arranged on the mounting body 1. A clamping space 4 (shown in FIG. 2) for mounting an external structure 5 or hardware (shown in FIG. 1) is formed between the locking toggle 3 and the clamping piece 2. The locking toggle 3 is further provided with a clamping part 31 for locking and mounting the external structure 5, for example, in the clamping space 4. When the locking toggle 3 moves to the locking position on the mounting body 1, the clamping part 31 is controlled to cooperate with the clamping piece 2 to clamp (or secure) the external structure 5 in the clamping space 4. When the locking toggle 3 leaves the locking position (i.e., not at the locking position or in an unlocked position), the clamping part 31 is controlled to loosen or release the external structure 5 from the clamping space 4. In some aspects, the locking toggle 3 may be provided with a damping structure for adjusting the friction force when the locking toggle 3 rotates, so as to increase the friction coefficient when the locking toggle 3 rotates, so that the locking toggle 3 cannot be easily separated (or released) from the locking position after moving to (or set in) the locking position on the mounting body 1 for locking the external structure 5.

When mounting the external structure 5, the external structure 5 can be directly mounted into (or secured in) the clamping space 4, and the clamping part 31 is controlled to cooperate with the clamping piece 2 to clamp (or secure) the external structure 5 through operating the movable locking toggle 3, thus realizing the mounting/unmounting and locking/unlocking process of the external structure 5. Compared with a slide-in mounting structure, the external structure 5 may be mounted on the locking mounting structure along a vertical or horizontal direction, the disclosed mounting methods are more diverse, and the mounting positions can be more quickly aligned for the desired mounting position or direction, thus optimizing the mounting operation.

In some aspects, a wrench 32 (or a handle or extension) for controlling the movement of the locking toggle is provided at one end of the locking toggle 3, and the clamping part 31 is located at a side of the other end of the locking toggle 3. In one aspect, the wrench 32 is operable to move close to or away from the clamping piece 2, so that the clamping part 31 can be controlled to cooperate with the clamping piece 2, such that the external structure 5 can be locked (secured) or loosened. Compared with the other locking methods, the locking and loosening process of the present disclosure is very simple and fast.

In some aspects, the clamping part 31 is provided with a first inclined plane 311 facing the lower side (shown as the top side in FIG. 2) of the mounting body 1, and the clamping piece 2 is provided with a second inclined plane 21 corresponding to the first inclined plane 311. With the arrangement of the first inclined plane 311 and the second inclined plane 21, the clamping part 31 can cooperate with the clamping piece 2 to clamp the external structure 5 more stably.

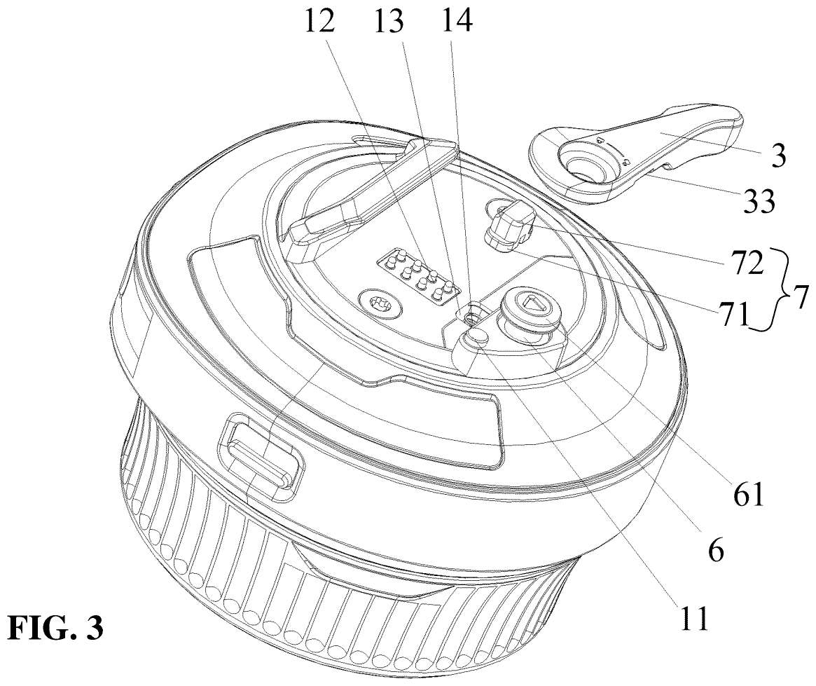

In some aspects, the locking mounting structure further includes a positioning piece 6 for locking the locking toggle 3, the positioning piece 6 is arranged on the mounting body 1, and the other end of the locking toggle 3 is rotatably sleeved on the positioning piece 6. The upper end of the positioning piece 6 is provided with a positioning part 61 (FIG. 3) for abutting against the locking toggle 3. In some aspects, the damping structure provided on the locking toggle 3 for adjusting the friction force during rotation abuts against the positioning part 61 correspondingly, or the damping structure is directly fixed on the positioning part 61 and abuts against the locking toggle 3 correspondingly. Therefore, the locking toggle 3 cannot be easily separated from the locking position after moving to or set in the locking position on the mounting body 1 for locking the external structure 5.

The locking toggle 3 can move (e.g., pivot) around the positioning piece 6 to control the clamping part 31 to cooperate with the clamping piece 2 to clamp or secure the external structure 5, or to control the clamping part 31 to movably loosen or release the external structure 5.

In some aspects, the lateral surface of the clamping part 31 is a cambered surface, and the locking toggle 3 or the clamping part 31 can rotate in an eccentric circle around the positioning piece 6.

The lateral surface of the clamping part 31 can be cambered, which can avoid scratching the external structure 5 mounted in the clamping space 4. The locking toggle 3 rotates in an eccentric circle to control the clamping part 31 to move into or out of the clamping space 4, so as to clamp/secure or loosen the external structure. In one example, when the locking toggle 3 or the clamping part 31 rotates to the side away from the clamping space 4, the area between the clamping part 31 and the clamping piece 2 becomes larger because the locking toggle 3/clamping part 31 is arranged to be rotatable in an eccentric circle (e.g., a circle that is slightly off-center) around the positioning piece 6, that is, the clamping space 4 becomes larger, thus facilitating the mounting/unmounting of the external structure 5 into/out of the clamping space 4. When the locking toggle 3/clamping part 31 rotates towards the side close to the clamping space 4, the area between the clamping part 31 and the clamping piece 2 becomes smaller because the locking toggle 3 is arranged to be rotatable in an eccentric circle around the positioning piece 6, that is, the clamping space 4 becomes smaller, thereby clamping and locking the external structure 5 in place.

In some aspects, the mounting body 1 is provided with a limit protrusion 11 (FIG. 3) corresponding to the locking toggle 3 to limit the rotation angle of the locking toggle 3, and the locking toggle 3 is provided with a limiting groove 33 corresponding to the limiting protrusion 11 (e.g., a pin, post, etc.). The cooperation of the limiting groove 33 and the limiting protrusion 11 can enhance the limiting effect.

In some aspects, the mounting body 1 is provided with a contact probe 12 (e.g., 8 probes shown in FIGS. 2 and 3) in the clamping space 4 for electrical connection. Due to the arrangement of the contact probe 12, the locking mounting structure can lock the external structure 5 in the clamping space 4, and also be electrically connected with the external structure 5.

In some aspects, the mounting body 1 is provided with a safety pin 7 that extends into the external structure 5 in the clamping space 4. After the external structure 5 is mounted in the clamping space 4, the safety pin 7 extends into the corresponding slot or opening (not shown) of the external structure 5, thus providing the functions of limiting and preventing the external structure 5 from falling off.

In some aspects, the mounting body 1 is provided with a safety pin groove 13 in the clamping space 4. The safety pin 7 is movably arranged in the safety pin groove 13, and a spring 14 is also arranged between the safety pin 7 and the safety pin groove 13. FIG. 3 shows the safety pin 7 removed from the safety pin groove 13.

The safety pin 7 includes a connecting part 71 and a pin body 72 which are connected together. The connecting part 71 can be accommodated or installed in the safety pin groove 13 and connected to the spring 14. In some aspects, the pin body 72 is convexly arranged in the external structure and located between the mounting body 1 and the clamping part 31. In this way, the clamping part 31 presses the upper surface of the side edge of the external structure 5, and the pin body 72 is located below the clamping part 31 and inserted into a corresponding opening (not shown) of the external structure 5, that is, the pin body 72 and the clamping part 31 cooperate to clamp one side of the external structure. It should be noted that the external structure includes a NATO (North Atlantic Treaty Organization) structure (NATO rail system) to facilitate the clamping piece 2 and the clamping part 31 to cooperate for locking.

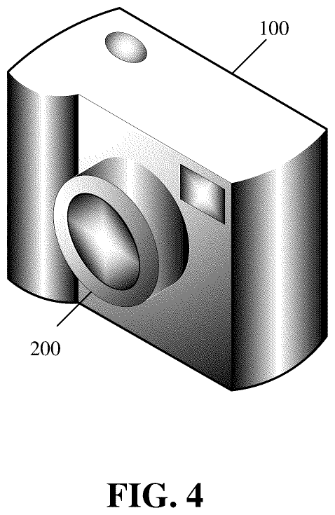

FIG. 4 is a conceptual diagram illustrating a photographic device 100, which includes the locking mounting structure 200 described above, wherein the locking mounting structure is mounted on the photographic device through the mounting body or the clamping space described above in relation to FIGS. 1-3.

The above are only the exemplary embodiments of the present disclosure, and are not intended to limit the present disclosure. Any modification, equivalent substitution and improvement made within the spirit and principle of the present disclosure should fall within the protection scope of the present disclosure.

The terminology used herein is for the purpose of describing particular examples only and is not intended to be limiting. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, processes, operations, elements, and/or components, but do not preclude the presence or addition of one or more other features, integers, processes, operations, elements, components, and/or groups thereof.

It is to be appreciated that the present disclosure is not limited to the exemplary terms used above to describe aspects of the present disclosure. For example, bandwidth may also be referred to as throughput, data rate or another term.

Any reference to an element herein using a designation e.g., “first,” “second,” and so forth does not generally limit the quantity or order of those elements. Rather, these designations are used herein as a convenient way of distinguishing between two or more elements or instances of an element. Thus, a reference to first and second elements does not mean that only two elements can be employed, or that the first element must precede the second element.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect electrical or other communicative coupling between two structures. Also, the term “approximately” means within ten percent of the stated value.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. A locking mounting structure, comprising:
a mounting body;
a clamping piece being fixedly arranged on the mounting body;
a locking toggle being movably arranged on the mounting body, a clamping space for mounting an external structure being provided between the locking toggle and the clamping piece; and
a clamping part extending from the locking toggle,
the locking toggle being movable in a first direction on the mounting body to control the clamping part to cooperate with the clamping piece to secure the external structure in the clamping space.

2. The locking mounting structure of claim 1, wherein the locking toggle is further configured to control the clamping part to move in a second direction to release the external structure from the clamping space.

3. The locking mounting structure of claim 1, further comprises:
a positioning piece arranged on the mounting body, the locking toggle being rotatably sleeved on the positioning piece.

4. The locking mounting structure of claim 3, wherein the clamping part comprises a lateral surface that is cambered, and the locking toggle is arranged to be rotatable in an eccentric circle around the positioning piece.

5. The locking mounting structure of claim 1, wherein the locking toggle comprises a wrench provided at a first end of the locking toggle for controlling a movement of the locking toggle, and the clamping part is located at a side of a second end of the locking toggle.

6. The locking mounting structure of claim 1, wherein a side of the clamping part facing the mounting body is provided with a first inclined plane, and the clamping piece is provided with a second inclined plane corresponding to the first inclined plane.

7. The locking mounting structure of claim 1, further comprising a limiting protrusion on the mounting body, the limiting protrusion corresponding to the locking toggle for limiting a rotation angle of the locking toggle, and the locking toggle comprises a limiting groove corresponding to the limiting protrusion.

8. The locking mounting structure of claim 1, further comprising a contact probe on the mounting body, the contact probe being in the clamping space for providing an electrical connection with the external structure.

9. The locking mounting structure of claim 1, further comprising a safety pin on the mounting body, the safety pin being in the clamping space and configured to extend into the external structure.

10. The locking mounting structure of claim 9, further comprising:
a safety pin groove in the mounting body, the safety pin groove being in the clamping space, the safety pin being movably arranged in the safety pin groove; and
a spring arranged between the safety pin and the safety pin groove.

11. A photographic device, comprising the locking mounting structure according to claim 1, wherein the locking mounting structure is mounted on the photographic device through the mounting body or the clamping space.
